(19) United States
(12) Patent Application Publication
(10) Pub. No.: US 2010/0171458 A1
(43) Pub. Date: Jul. 8, 2010

(54) SERVO CONTROLLER

(75) Inventors: Manabu Hamaguchi, Tokyo (JP); Tomohiro Miyazaki, Tokyo (JP)

Correspondence Address: SUGHRUE-265550, 2100 PENNSYLVANIA AVE. NW, WASHINGTON, DC, 20037-3213, US

(73) Assignee: MITSUBISHI ELECTRIC CORPORATION, Tokyo (JP)

(21) Appl. No.: 12/376,821

(22) PCT Filed: Sep. 27, 2007
(86) PCT No.: PCT/JP2007/068753

§ 371 Date: Feb. 9, 2009

(30) Foreign Application Priority Data
Sep. 28, 2006 (JP) 2006-265277

(51) Int. Cl. G05B 11/06; H02P 5/50

(52) U.S. Cl. 318/625

(57) ABSTRACT

A servo controller which drives one movable member 1 by means of a plurality of motors including one main motor 31 and at least one sub motor 41 includes: a main-motor controlling unit 30 for controlling driving of the main motor 31; and at least one sub-motor controlling unit 40 for controlling driving of the at least one sub motor 41. The sub-motor controlling unit 40 includes a sub-motor position controlling unit 44 and a sub-motor velocity controlling unit 45. Both the sub-motor position controlling unit 44 and the sub-motor velocity controlling unit 45 do not have an integral characteristic.

### TECHNICAL FIELD

The present invention relates to a servo controller which controls driving of a feed shaft of a machine tool, another industrial machine, or the like, and more particularly to a servo controller in which one movable member is driven by a plurality of motors.

### BACKGROUND ART

A conventional servo controller in the case where one movable member is driven by a plurality of motors is configured as shown in FIG. 3. In FIGS. 3, 11 and 21 denote motors which drive a movable member 1, 12 and 22 denote position detecting means for detecting positions of the motors 11, 21, 13 and 23 denote velocity detecting means for detecting velocities of the motors 11, 21, 14 and 24 denote position controlling means for receiving a position command given from a higher level controller which is not shown, controlling so that the positions detected by the position detecting means 12, 22 follow the position command, and outputting a velocity command, 15 and 25 denote velocity controlling means for receiving velocity commands output from the position controlling means 14, 24, and outputting a current command so that the velocities detected by the velocity detecting means 13, 23 follow the velocity commands, and 16 and 26 denote current controlling means for controlling motor currents in accordance with the current commands output from the velocity controlling means 15, 25.

In the position controlling means 14, 24, a proportional control such as shown in the block diagram of FIG. 4 is performed. In FIG. 4, 50 denotes a comparator which subtracts the motor position detected by the position detecting means 12 or 22 from the position command to output a position deviation, and 51 denotes a position gain element which multiplies the position deviation that is the output of the comparator 50, with a constant Kp to output a velocity command. In this way, the position controlling means 14, 24 multiply the position deviation with the constant gain Kp, and output the multiplication result as the velocity command.

In the velocity controlling means 15, 25, a proportional control and an integral control are performed. FIG. 5 is a block diagram showing in detail the velocity controlling means 15, 25. In FIG. 5, 52 denotes a comparator which outputs a velocity deviation that is a value obtained by subtracting the motor velocity detected by the velocity detecting means 13 or 23 from the velocity command, 53 denotes a velocity gain element which multiplies the velocity deviation with a constant Kv, and which outputs the multiplication result, 54 denotes an integrator which integrates the velocity deviation, 55 denotes an integral gain element which multiplies the integral value of the integrator 54 with a constant Ki, and 56 denotes an adder which adds the output of the velocity gain element 53 and the output of the integral gain element 55, and which outputs the addition result as the current command.

The velocity controlling means 15, 25 perform proportional and integral controls because, also in the case where a constant external force acts on the motors, integrators are required in order to allow the motor positions detected by the position detecting means 12, 22 to follow the position command without deviation. In the case where an external force acts on the motors, the external force causes a position deviation. In the case where a position deviation is caused by an external force, the position controlling means 14, 24 output velocity commands corresponding to the position deviation. The velocity commands are input to the velocity controlling means 15, 25, and integrated by the integrators 54. Therefore, the integral values of the integrators 54 are increased, and also the current commands output from the velocity controlling means 15, 25 are increased. Until the position deviation becomes zero, the integral values are increased, and also the current commands are increased. Finally, therefore, the motors generate a torque counteracting the acting external force, and the position deviation is eliminated.

Although the example in which the position controlling means 14, 24 perform a proportional control and the velocity controlling means 15, 25 perform proportional and integral controls has been described, there is also a case where the position controlling means 14, 24 perform proportional and integral controls. Also in this case, similarly, a position deviation is integrated in the integrators of the position controlling means 14, 24, and the current commands are increased in accordance with the integration. Also in the case where a constant external force acts on the motors, therefore, the position deviation is eliminated. When a control system is configured so that at least one of position controlling means and velocity controlling means includes an integrator in this manner, a position deviation can be eliminated according to the known internal model principle also in the case where a constant external force acts on motors.

The conventional servo controller is configured as described above so that the same position command is given to the two motors 11, 21, and the motors are controlled so as to follow the position command, whereby the one movable member 1 is driven.

In order to clarify problems of the conventional servo controller, the case where different detection errors exist in the position detecting means 12, 22 will be considered. As described above, the motors operate so as to follow a position command given from a higher-level controller, and are positioned at the same position. In the case where a detection error exists in a position detector, even when the motor position detected by the position detector coincides with the command position, however, the position is displaced from the actual motor position. The two motors 11, 12 are mechanically connected to each other by the movable member 1. When a position displacement occurs between the two motors, therefore, an external force for returning to the same position acts on the motors. Because of the functions of the integrators 54 of the velocity controlling means 15, 25, however, the motors produce a large torque counteracting the external force acting on the motors as describes above, so as to eliminate the position deviation.

In the conventional servo controller, as described above, when a detection error exists in the position detector, the motors generate excessive torques in order to eliminate a position deviation, and hence there is a problem in that this causes heat generation and overload of the motors. Furthermore, there is another problem in that the torques produced by the motors cause the mechanical system including the movable member 1 to be distorted and the mechanical system is subjected to stress.

As a technique for solving these problems and suppressing excessive torques generated by motors, there is a technique in which a synchronization correction processing portion is disposed that compares torque commands of motors with each other, and that corrects the position deviation(s) of one or both of the motors so that the difference of the torque commands becomes small. Namely, the position deviation(s) is corrected to reduce the difference of the torque commands by additionally disposing the synchronization correction processing portion, whereby excessive torques generated by the motors can be suppressed (for example, see Patent Reference 1).

Patent Reference 1: JP-A-2004-288164

### DISCLOSURE OF THE INVENTION

### Problems that the Invention is to Solve

In the conventional servo controller, as described above, there is the problem in that, when a detection error exists in position detectors for motors, excessive torques are generated in the motors.

In the technique disclosed in Patent Reference 1, although excessive torques generated by the motors can be suppressed, the synchronization correction processing portion must be additionally disposed, and hence the amount of calculation is increased, thereby producing a problem in that a controller having a higher processing capacity than a conventional controller must be used.

The invention has been conducted in order to solve the problems. It is an object of the invention to obtain a servo controller which can suppress excessive torques generated by motors with a small amount of calculation.

### Means for Solving the Problem

The servo controller of the invention is a servo controller which drives one movable member by means of a plurality of motors including one main motor and at least one sub motor, wherein the servo controller includes: main-motor controlling means for controlling driving of the main motor; and at least one sub-motor controlling means for controlling driving of the at least one sub motor, the main-motor controlling means includes: main-motor position detecting means for detecting a position of the main motor; main-motor velocity detecting means for detecting a velocity of the main motor; main-motor position controlling means for receiving a given position command, and outputting a current command for the main motor to cause the position of the main motor detected by the main-motor position detecting means, to follow the position command; and main-motor current controlling means for receiving the current command output from the main-motor position controlling means, and controlling a current of the main motor, the sub-motor controlling means includes: sub-motor position detecting means for detecting a position of the sub motor; sub-motor velocity detecting means for detecting a velocity of the sub motor; sub-motor position controlling means for receiving the position of the main motor detected by the main-motor position detecting means, as a position command, and outputting a velocity command for the sub motor to cause the position of the sub motor detected by the sub-motor position detecting means, to follow the position of the main motor; sub-motor velocity controlling means for receiving an added value of the velocity command output from the sub-motor position controlling means and the velocity of the main motor detected by the main-motor velocity detecting means, as a new velocity command, and outputting a current command for the sub motor to cause the velocity of the sub motor detected by the sub-motor velocity detecting means, to follow the new velocity command; and sub-motor current controlling means for receiving an added value of the current command output from the main-motor position controlling means and the current command output from the sub-motor velocity controlling means, as a new current command, and controlling a current of the sub motor, and the sub-motor position controlling means and the sub-motor velocity controlling means do not have an integral characteristic.

Moreover, in the servo controller of the invention, in the above, the sub-motor position controlling means and the sub-motor velocity controlling means are configured by a proportional control, or a proportional control and an incomplete integral control.

Moreover, the servo controller of the invention is a servo controller which drives one movable member by means of a plurality of motors including one main motor and at least one sub motor, wherein the servo controller includes: main-motor controlling means for controlling driving of the main motor; and at least one sub-motor controlling means for controlling driving of the at least one sub motor, the main-motor controlling means includes: main-motor position detecting means for detecting a position of the main motor; main-motor velocity detecting means for detecting a velocity of the main motor; main-motor position controlling means for receiving a given position command, and outputting a current command for the main motor to cause the position of the main motor detected by the main-motor position detecting means, to follow the position command; and main-motor current controlling means for receiving the current command output from the main-motor position controlling means, and controlling a current of the main motor, and the sub-motor controlling means includes: sub-motor velocity detecting means for detecting a velocity of the sub motor; sub-motor velocity controlling means for receiving the velocity of the main motor detected by the main-motor velocity detecting means, as a velocity command, and outputting a current command for the sub motor to cause the velocity of the sub motor detected by the sub-motor velocity detecting means, to follow the velocity of the main motor; and sub-motor current controlling means for receiving an added value of the current command output from the main-motor position controlling means and the current command output from the sub-motor velocity controlling means, as a new current command, and controlling a current of the sub motor.

Moreover, in the servo controller of the invention, in the above, the sub-motor velocity controlling means does not have an integral characteristic.

Furthermore, in the servo controller of the invention, in the above, the sub-motor velocity controlling means is configured by a proportional control, or a proportional control and an incomplete integral control.

### EFFECTS OF THE INVENTION

According to the invention, the sub-motor position controlling means and the sub-motor velocity controlling means are configured so as not to have an integral characteristic. Therefore, there is an advantage that, even when a detection error exists in position detectors for the motors, excessive torques of the motors can be suppressed with a small amount of calculation.

According to the invention, moreover, the sub-motor position controlling means and the sub-motor velocity controlling means perform a proportional control, or two controls of a proportional control and an incomplete integral control. Therefore, there is an advantage that, even when a detection error exists in position detectors for the motors, excessive torques of the motors can be suppressed with a small amount of calculation.

According to the invention, moreover, a position control loop of the sub-motor controlling means is eliminated, and the control is performed by means of a velocity loop. Therefore, there is an advantage that, even when a detection error exists in position detectors for the motors, excessive torques of the motors can be suppressed with a small amount of calculation.

According to the invention, moreover, the sub-motor velocity controlling means does not have an integral characteristic. Therefore, there is an advantage than, even when a detection error exists in position detectors for the motors, excessive torques of the motors can be suppressed with a small amount of calculation.

According to the invention, furthermore, the sub-motor velocity controlling means is configured by a proportional control, or two controls of a proportional control and an incomplete integral control. Therefore, there is an advantage that, even when a detection error exists in position detectors for the motors, excessive torques of the motors can be suppressed with a small amount of calculation.

### BRIEF DESCRIPTION OF THE DRAWINGS

FIG. 1 is a block diagram of a servo controller showing Embodiment 1 of the invention.

FIG. 2 is a block diagram of a servo controller showing Embodiment 2 of the invention.

FIG. 3 is a block diagram of a conventional servo controller.

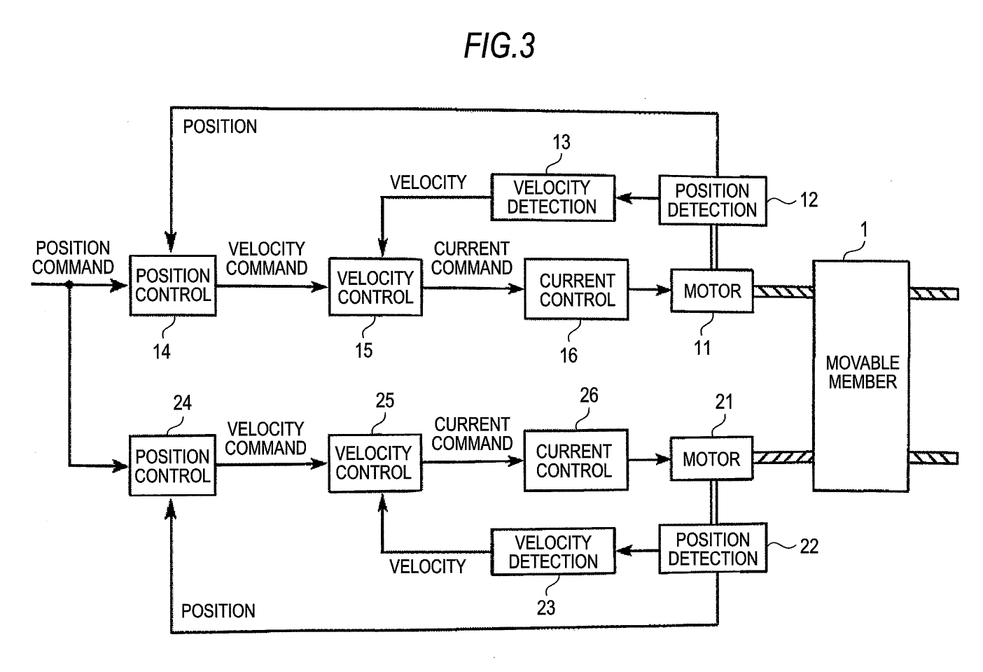

FIG. 4 is a block diagram of a proportional control.

FIG. 5 is a block diagram of proportional and integral controls.

FIG. 6 is a block diagram of proportional and incomplete integral controls.

### DESCRIPTION OF REFERENCE NUMERALS AND SIGNS

1 movable member
12, 22 position detecting means
13, 23 velocity detecting means
14, 24 position controlling means
15, 25 velocity controlling means
16, 26 current controlling means
30 main-motor controlling means
31 main motor
32 main-motor position detecting means
33 main-motor velocity detecting means
34 position controlling means
35 velocity controlling means
36 main-motor current controlling means
40 sub-motor controlling means
41 sub motor
42 sub-motor position detecting means
43 sub-motor velocity detecting means
44 sub-motor position controlling means
45 sub-motor velocity controlling means
46 sub-motor current controlling means

### BEST MODE FOR CARRYING OUT THE INVENTION

### Embodiment 1

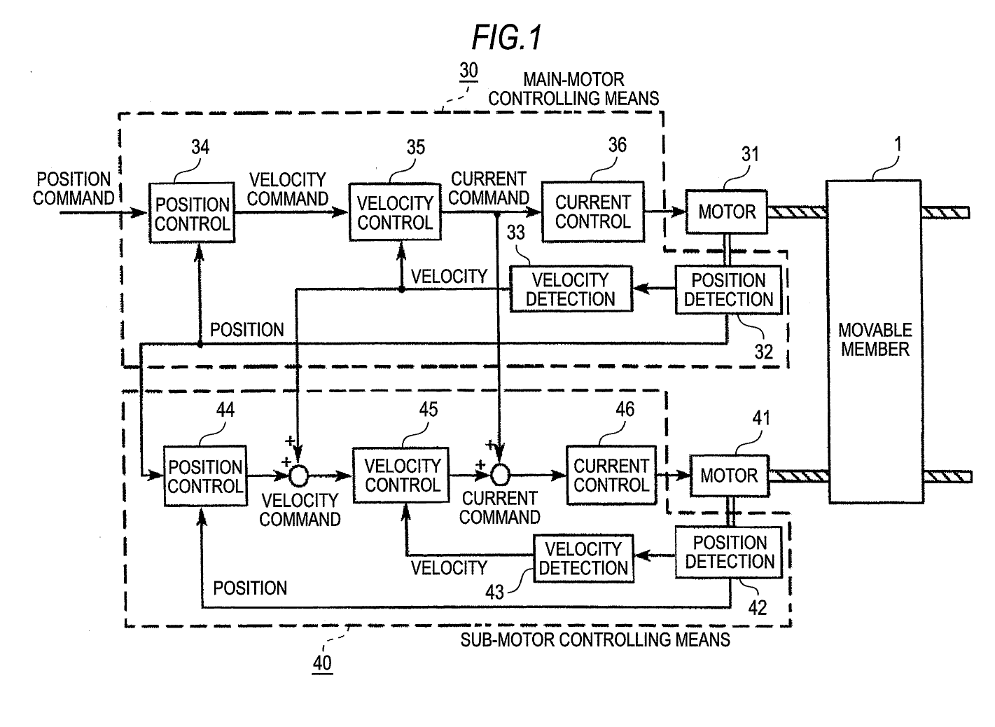

FIG. 1 shows a block diagram of a servo controller of Embodiment 1 of the invention. In FIG. 1, 31 denotes a main motor, 41 denotes a sub motor, 1 denotes a movable member which is driven by the main motor 31 and the sub motor 41, 30 denotes main-motor controlling means which controls driving of the main motor 31, and 40 denotes sub-motor controlling means which controls driving of the sub motor 41.

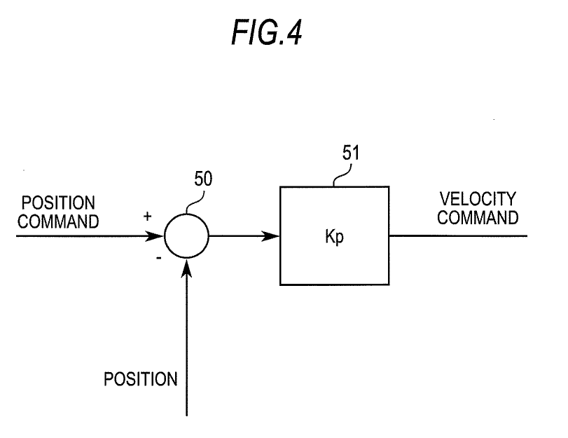

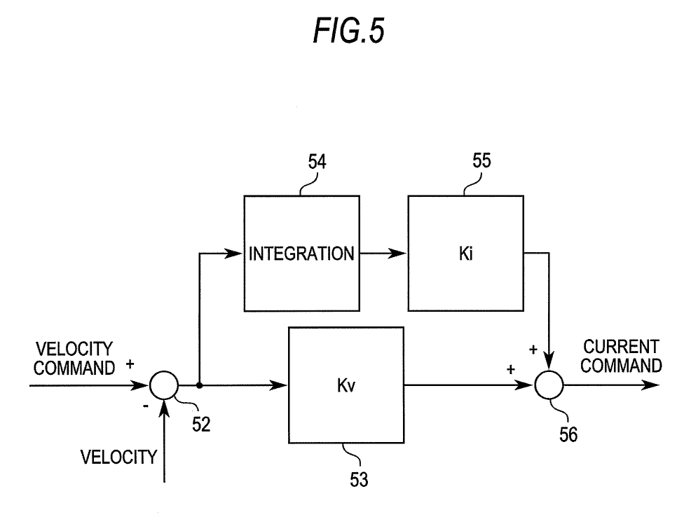

The main-motor controlling means 30 is configured by main-motor position detecting means 32, main-motor velocity detecting means 33, position controlling means 34, velocity controlling means 35, and main-motor current controlling means 36. The position controlling means 34 and the velocity controlling means 35 constitute main-motor position controlling means. The position controlling means 34 receives a position command given from a higher level controller which is not shown, and outputs a velocity command so that the position of the main motor 31 detected by the main-motor position detecting means 32 follows the position command. In the main-motor position controlling means 34, a proportional control shown in FIG. 4 is performed. The velocity controlling means 35 receives a velocity command output from the position controlling means 34, and outputs a current command so that the velocity detected by the velocity detecting means 33 follows the velocity command. The main-motor velocity controlling means 35 performs proportional and integral controls such as shown in FIG. 5. The main-motor current controlling means 36 receives the current command output by the velocity controlling means 35, and controls the current of the main motor 31. The main-motor controlling means 30 is configured in this way, and controls the driving of the main motor 31 so as to follow the position command given from the higher-level controller.

The sub-motor controlling means 40 is configured by sub-motor position detecting means 42, sub-motor velocity detecting means 43, sub-motor position controlling means 44, sub-motor velocity controlling means 45, and sub-motor current controlling means 46. Here, the sub-motor position controlling means 44 receives the position of the main motor 31 detected by the main-motor position detecting means 32, as a position command, controls the position of the sub motor 41 detected by the sub-motor position detecting means 42 so as to follow the position of the main motor 31, and outputs a velocity command of the sub motor 41. However, the sub-motor position controlling means 44 performs the proportional control shown in FIG. 4, and does not have an integral characteristic. The sub-motor velocity controlling means 45 receives an added value of the velocity command output from the sub-motor position controlling means 44 and the velocity of the main motor 31 detected by the main-motor velocity detecting means 33, as a new velocity command, and outputs a current command for the sub motor 41 to cause the velocity of the sub motor 41 detected by the sub-motor velocity detecting means 43, to follow the new velocity command. Also the sub-motor velocity controlling means 45 performs the proportional control such as shown in FIG. 4, and does not have an integral characteristic. Furthermore, the sub-motor current controlling means 46 receives an added value of the current command output from the main-motor position controlling means and the current command output from the sub-motor velocity controlling means 45, as a new current command, and controls the current of the sub motor 41.

The sub-motor controlling means 40 is configured in this way, and controls the sub motor 41 on the basis of the position, velocity, and current commands of the main motor 31, whereby the sub motor 41 is caused to operate to follow the motion of the main motor 31.

As described above, the main motor 31 operates to follow the position command given from the higher level controller, and the sub motor 41 operates to follow the motion of the main motor 31, thereby enabling the two motors to drive the one movable member 1.

Next, the case where there is a detection error in the main-motor position detecting means 32 and the sub-motor position detecting means 42 will be described. The main-motor velocity controlling means 35 performs proportional and integral controls, and includes an integrator. Therefore, the control is performed so that the position deviation from the position command becomes zero. In the sub-motor controlling means 40, by contrast, both the sub-motor position controlling means 44 and the sub-motor velocity controlling means 45 perform a control which does not have an integral characteristic. Unlike the conventional servo controller, therefore, the phenomenon that the current command is increased until the position deviation becomes zero does not occur, and the generation of an excessive torque in the sub motor 41 is suppressed. Since an external force acting on the main motor 31 is a reaction of a torque generated by the sub motor 41, the external force acting on the main motor 31 is smaller as the torque generated by the sub motor 41 is smaller, with the result that, also in the main motor 31, the generation of an excessive torque is suppressed.

According to Embodiment 1, in this way, both the sub-motor position controlling means 44 and the sub-motor velocity controlling means 45 are configured so as not to have an integral characteristic, and hence excessive torques which may be generated by the motors can be suppressed. In Embodiment 1, moreover, it is not required to additionally dispose a synchronization correction processing portion unlike Patent Reference 1, and therefore, the generation of an excessive torque can be suppressed with a small amount of calculation.

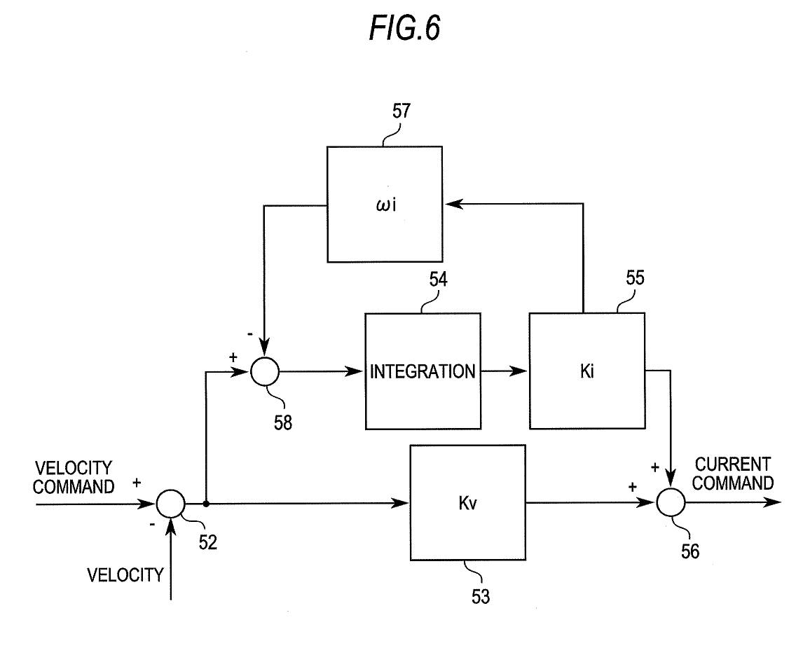

In the embodiment, the sub-motor position controlling means 44 and the sub-motor velocity controlling means 45 perform a proportional control. When both the means are configured so as not to have an integral characteristic, similar effects are attained. Alternatively, therefore, these means may perform proportional and incomplete integral controls. FIG. 6 shows a block diagram in the case where the sub-motor velocity controlling means 45 performs proportional and incomplete integral controls. This case has a form in which a coefficient 57 and a subtractor 58 are added to the proportional and integral controls of FIG. 5. When the output of the integrator 54 is fed back to the input of the integrator 54 through the coefficient 57 in this manner, an incomplete integration is performed, and the input/output characteristics of the sub-motor velocity controlling means 45 does not have a pure integral characteristic.

### Embodiment 2

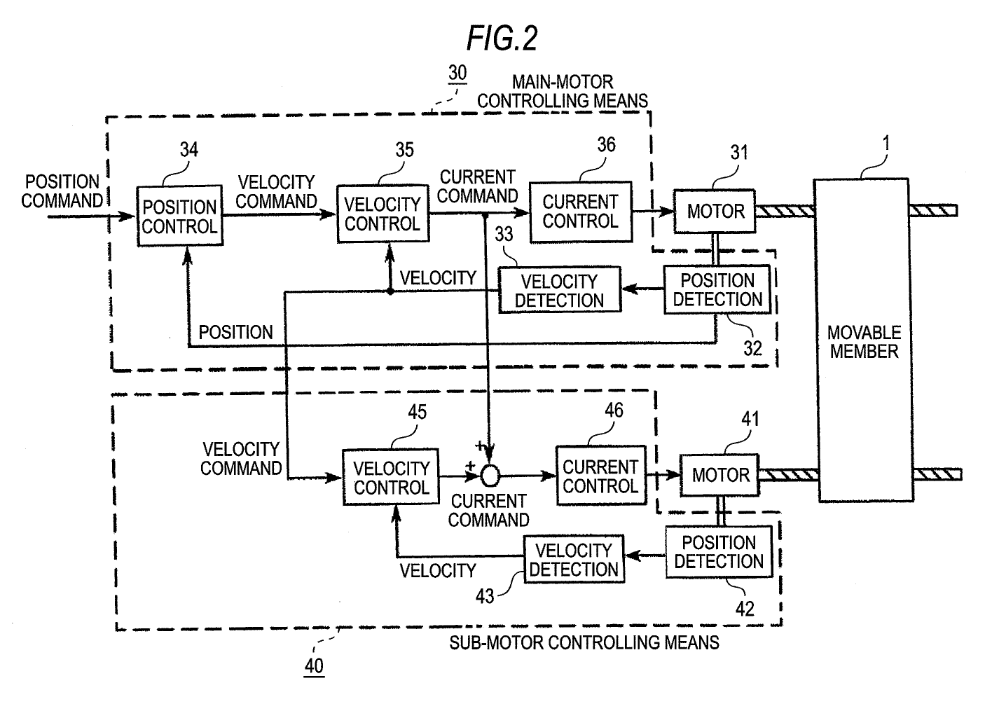

FIG. 2 shows a block diagram of a servo controller of Embodiment 2 of the invention. The same components as FIG. 1 are denoted by the identical reference numerals, and their description is omitted. FIG. 2 is configured by omitting the position control loop of the sub-motor controlling means 40 from FIG. 1 showing Embodiment 1. According to this configuration, the velocity of the main motor 31 detected by the main-motor velocity detecting means 33 is input to the sub-motor velocity controlling means 45 as the velocity command.

In the conventional servo controller, the current command is increased until the position deviation is eliminated, thereby causing the motors to generate an excessive torque. In the servo controller of Embodiment 2, by contrast, since the sub-motor controlling means 40 is not provided with a position control loop, the phenomenon that the current command is increased until the position deviation is eliminated does not occur, and the generation of an excessive torque in the sub motor 41 is suppressed. Since an external force acting on the main motor 31 is a reaction of a torque generated by the sub motor 41, the external force acting on the main motor 31 is smaller as the torque generated by the sub motor 41 is smaller, with the result that, also in the main motor 31, the generation of an excessive torque is suppressed.

According to Embodiment 2, in this way, the sub-motor controlling means 4G is configured so as not to have a position control loop, and hence excessive torques which may be generated by the motors can be suppressed. In Embodiment 2, moreover, it is not required to additionally dispose a synchronization correction processing portion unlike Patent Reference 1, and moreover the position control loop of the sub-motor controlling means 40 is removed away. Therefore, the generation of an excessive torque can be suppressed with a small amount of calculation.

In Embodiment 2, the generation of an excessive torque is suppressed by removing away the position control loop from the sub-motor controlling means 40. Even when the sub-motor velocity controlling means 45 performs proportional and integral controls, therefore, the generation of an excessive torque is suppressed.

When the sub-motor velocity controlling means 40 is configured by a proportional control, or proportional and incomplete integral controls so as not to have an integral characteristic, a torque suppressing effect due to the configuration having no integral characteristic, as shown in Embodiment 1 is further added, so that a greater torque suppressing effect can be attained.

In Embodiments 1 and 2, the case where one sub motor is used has been described. Even when two or more sub motors are used, the servo controller can be configured in a similar manner, and similar effects are obtained.

### INDUSTRIAL APPLICABILITY

The servo controller of the invention is suitable to be used as a servo controller for controlling driving of one movable member by means of a plurality of motors, in a feed shaft of a machine tool or another industrial machine, or the like.

1. A servo controller which drives one movable member by means of a plurality of motors including one main motor and at least one sub motor, wherein
the servo controller includes: a main-motor controlling unit for controlling driving of the main motor; and at least one sub-motor controlling unit for controlling driving of the at least one sub motor,
the main-motor controlling unit includes: a main-motor position detecting unit for detecting a position of the main motor; a main-motor velocity detecting unit for detecting a velocity of the main motor; a main-motor position controlling unit for receiving a given position command, and an outputting a current command for the main motor to cause the position of the main motor detected by the main-motor position detecting unit, to follow the position command; and a main-motor current controlling unit for receiving the current command output from the main-motor position controlling unit, and controlling a current of the main motor,
the sub-motor controlling unit includes: a sub-motor position detecting unit for detecting a position of the sub motor; a sub-motor velocity detecting unit for detecting a velocity of the sub motor; a sub-motor position controlling unit for receiving the position of the main motor detected by the main-motor position detecting unit, as a position command, and outputting a velocity command for the sub motor to cause the position of the sub motor detected by the sub-motor position detecting unit, to follow the position of the main motor; a sub-motor velocity controlling unit for receiving an added value of the velocity command output from the sub-motor position controlling unit and the velocity of the main motor detected by the main-motor velocity detecting unit, as a new velocity command, and outputting a current command for the sub motor to cause the velocity of the sub motor detected by the sub-motor velocity detecting unit, to follow the new velocity command; and a sub-motor current controlling unit for receiving an added value of the current command output from the main-motor position controlling unit and the current command output from the sub-motor velocity controlling unit, as a new current command, and controlling a current of the sub motor, and
the sub-motor position controlling unit and the sub-motor velocity controlling unit do not have an integral characteristic.

2. The servo controller according to claim 1,
wherein the sub-motor position controlling unit and the sub-motor velocity controlling unit are configured by a proportional control, or a proportional control and an incomplete integral control.

3. (canceled)

4. A servo controller which drives one movable member by means of a plurality of motors including one main motor and at least one sub motor, wherein
the servo controller includes: a main-motor controlling unit for controlling driving of the main motor; and at least one sub-motor controlling unit for controlling driving of the at least one sub motor,
the main-motor controlling unit includes: a main-motor position detecting unit for detecting a position of the main motor; a main-motor velocity detecting unit for detecting a velocity of the main motor; a main-motor position controlling unit for receiving a given position command, and outputting a current command for the main motor to cause the position of the main motor detected by the main-motor position detecting unit, to follow the position command; and a main-motor current controlling unit for receiving the current command output from the main-motor position controlling unit, and controlling a current of the main motor,
the sub-motor controlling unit includes: a sub-motor velocity detecting unit for detecting a velocity of the sub motor; a sub-motor velocity controlling unit for receiving the velocity of the main motor detected by the main-motor velocity detecting unit, as a velocity command, and outputting a current command for the sub motor to cause the velocity of the sub motor detected by the sub-motor velocity detecting unit, to follow the velocity of the main motor; and a sub-motor current controlling unit for receiving an added value of the current command output from the main-motor position controlling unit and the current command output from the sub-motor velocity controlling unit, as a new current command, and controlling a current of the sub motor, and
the sub-motor velocity controlling unit does not have an integral characteristic.

5. The servo controller according to claim 4,
wherein the sub-motor velocity controlling unit is configured by a proportional control, or a proportional control and an incomplete integral control.
